(19) United States
(12) Patent Application Publication
(10) Pub. No.: US 2009/0052309 A1
(43) Pub. Date: Feb. 26, 2009

(54) OPTICAL DISC COMPRISING RF TRANSPONDER

(75) Inventor: Alwyn Jakobus Hoffman, Potchefstroom (ZA)

Correspondence Address: OSTROLENK FABER GERB & SOFFEN, 1180 AVENUE OF THE AMERICAS, NEW YORK, NY, 100368403, US

(73) Assignee: IP AND INNOVATION COMPANY HOLDINGS (PTY) LIMITED, Pretoria (ZA)

(21) Appl. No.: 11/574,335

(22) PCT Filed: Aug. 26, 2005
(86) PCT No.: PCT/IB2005/052802

§ 371 Date: Oct. 1, 2008

(30) Foreign Application Priority Data
Aug. 27, 2004 (ZA) 2004/6840

(51) Int. Cl. G11B 7/00

(52) U.S. Cl. 369/273; 720/718; 340/10.1

(57) ABSTRACT

An optical disc having a center, an outer periphery and a metal layer between the center and the outer periphery. A tag comprising a radio frequency transponder is located in a region adjacent the outer periphery. This arrangement facilitates reading the transponder with an external reader when a plurality of discs are stacked one on top of the other.

### TECHNICAL FIELD

This invention relates to optical discs and more particularly to optical discs carrying a tag comprising a radio frequency identification (RFID) transponder.

In US 2003/0028787 A1 there is disclosed a computer software product stored on a computer readable disc, such as an optical disc, carrying a tag comprising a transponder associated with an RFID system. The tag is attached or embedded in the disc. Before the product can be installed on a user's computer, a reader of the RFID system forming part of the computer interrogates the transponder on a one to one basis for an identification code stored in a memory arrangement of the transponder. The code received is verified by the reader and installation software is enabled to install the product only in the event that a correct or authorized code is received from the transponder. In a preferred embodiment, the tag is attached to the disc in a region thereof about midway between the centre of the disc and an outer periphery of the disc.

In applications wherein a plurality of stacked discs are to be read by a reader, the aforementioned configuration would not work satisfactorily, mainly because metal layers of discs between the reader and a target disc would screen and/or reflect interrogation and/or energizing and response signals if passive or semi-active backscattering RFID technology is used. Similarly, the reading of transponders on stacked discs will be problematic if magnetic coupling RFID technology is used, because the close proximity of transponders to neighbouring transponders may have the effect to de-tune the transponders.

### OBJECT OF THE INVENTION

Accordingly, it is an object of the present invention to provide an optical disc and a method of manufacturing a disc with which the applicant believes the aforementioned disadvantages may at least be alleviated.

### SUMMARY OF THE INVENTION

According to the invention there is provided an optical disc comprising a center and an outer periphery, a metal layer between the center and the outer periphery; and at least a first radio frequency transponder located in a region adjacent the outer periphery.

The disc may be circular and the metal layer may have an inner circular boundary adjacent the center and an outer circular boundary adjacent the outer periphery of the disc, the at least first transponder being located in an annular band between the outer boundary and the outer periphery.

The transponder may be mounted on an external surface of the disc, alternatively it may be embedded in the disc, for example by sandwiching it between first and second circular dielectric body parts of the disc superimposed on one another.

The at least first transponder may comprise a chip comprising electronic circuitry and an antenna. The antenna may comprise two parts located on either side of the chip. The antenna may be configured in the form of a circle segment.

In a first embodiment of the disc, the first body part may comprise the metal layer and the transponder may be mounted on an inside face of the first body part. The first and second body parts may be transparent. The chip may be located in a socket or recess defined in the first body part, alternatively in the second body part.

A second and similar transponder may be provided on the first or the second body part in a region diametrically opposed to the first transponder. In other embodiments a suitable counter mass may be provided either diametrically opposed to the first transponder or in any other suitable place on the disc.

In still other embodiments the at least first transponder is provided in a radially outer region of the second body part, so that when the first and second body parts are superimposed on one another, the at least first transponder is located in the aforementioned annular band.

The second transponder may also be provided on the second body part, so that it is located in the aforementioned band.

If a counter mass is utilized, it may be located in any suitable position on the disc.

In other embodiments, at least the antenna may be formed or located on an axially and circumferentially extending edge of the disc.

In still other embodiments the disc is circular having a center axis and the transponder is mounted on an external surface in an axially extending groove defined on a circle coaxial with the center axis.

Also included within the scope of the present invention is a method of producing an optical disc, the method comprising the steps of providing a radio frequency transponder on the disc in a region thereof towards an outer periphery of the disc.

The transponder may be sandwiched between a first dielectric and circular body part and a second similar body part of the disc.

The transponder may comprise an antenna and the antenna may be provided on an operatively inside face of a first body part of the disc with the same process and simultaneously with the metal layer. In other forms of the method, the antenna may be provided on said surface by any other suitable process simultaneously or before or after the metal layer is formed.

In other embodiments the transponder may be formed on an operatively inside face of a second body part of the disc.

For example, the antenna may be formed on an inside face of one of the first and second body parts of the disc and the chip may be received in a radially inwardly extending peripheral socket defined in the disc when assembled.

In other embodiments the transponder may be provided on an external surface of the disc in an axially extending groove defined on a circle coaxial with a center of the disc.

In still other embodiments, the transponder may be provided in the form of a tag on an external surface of the disc. The tag may comprise a substrate and the substrate may be adhered or otherwise applied to the external surface.

Also included within the scope of the present invention is a tag comprising an elongate substrate and an antenna on the substrate, the antenna being configured in the form of a circle segment and being connected to a chip carrying or embodying electronic circuits and which chip is also mounted on the substrate. The substrate may also be configured in the form of a circle segment. Lines of perforations or weakness may be provided in the substrate to extend transversely to a longitudinal axis of the substrate.

### BRIEF DESCRIPTION OF THE ACCOMPANYING DIAGRAMS

The invention will now further be described, by way of example only, with reference to the accompanying diagrams wherein:

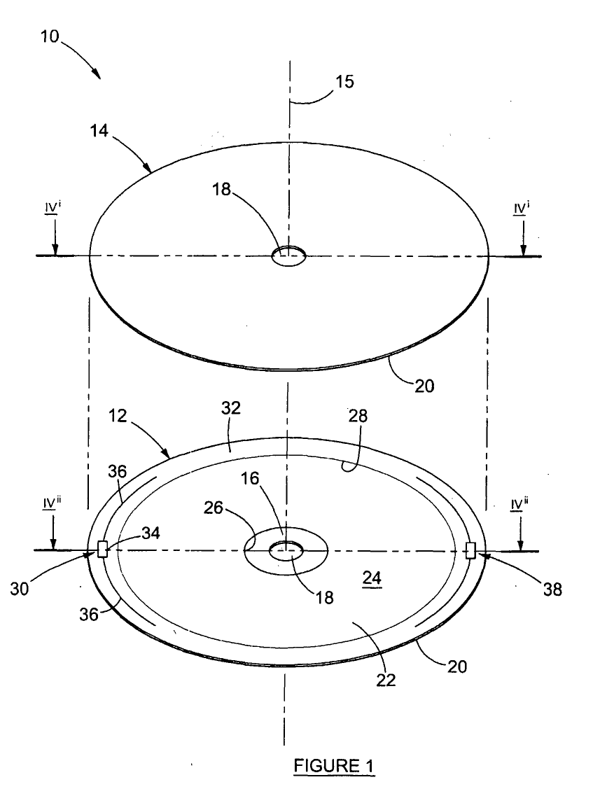

FIG. 1 is a diagrammatic exploded perspective view of a first embodiment of an optical disc according to the invention;

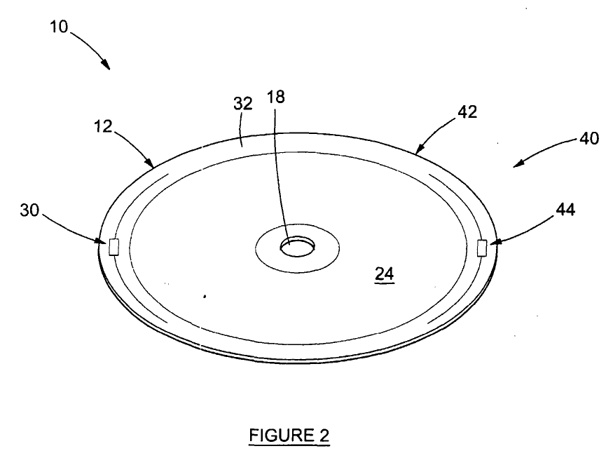

FIG. 2 is a diagrammatic perspective view of a first body part of a second embodiment of the disc according to the invention;

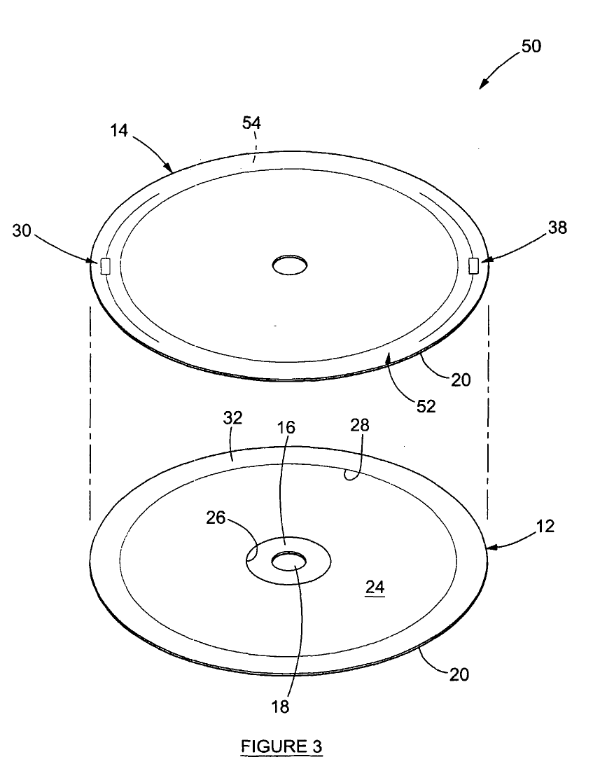

FIG. 3 is a diagrammatic exploded perspective view of a third embodiment of the disc according to the invention;

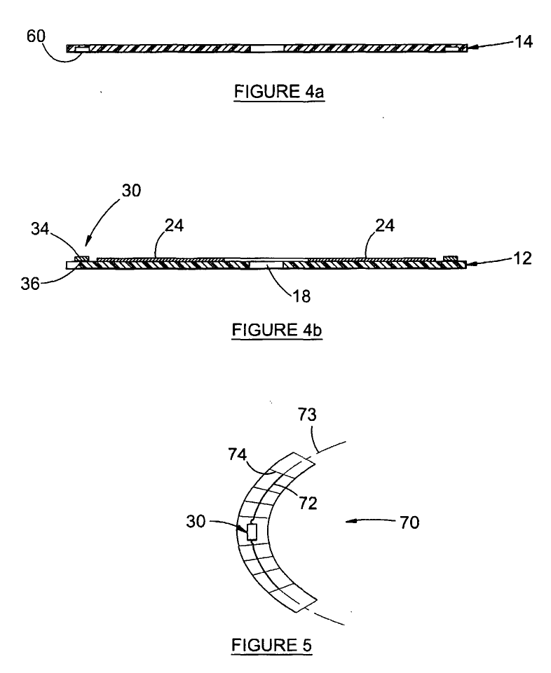

FIG. 4(a) is a section on line IV′ in FIG. 1;

FIG. 4(b) is a section on line IV″ in FIG. 1;

FIG. 5 is a top elevation of a tag according to the invention for use on a disc according to the invention;

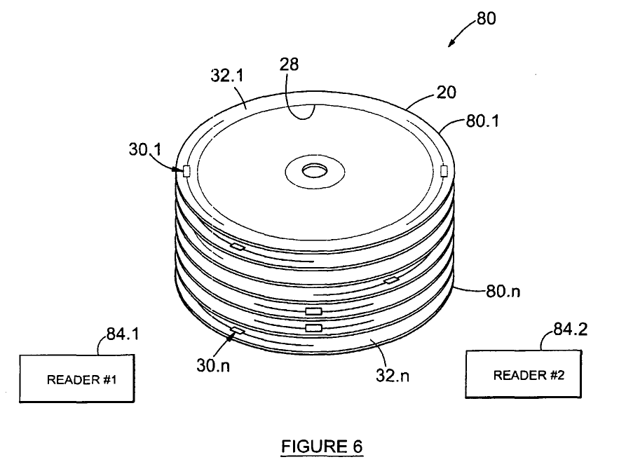

FIG. 6 is a perspective view of a stack comprising a plurality of discs according to the invention;

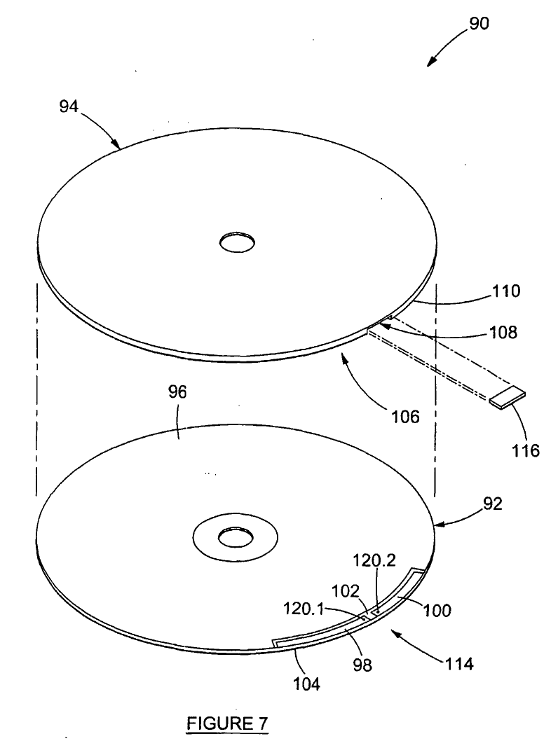

FIG. 7 is a diagrammatic exploded perspective view of a fourth embodiment of an optical disc according to the invention;

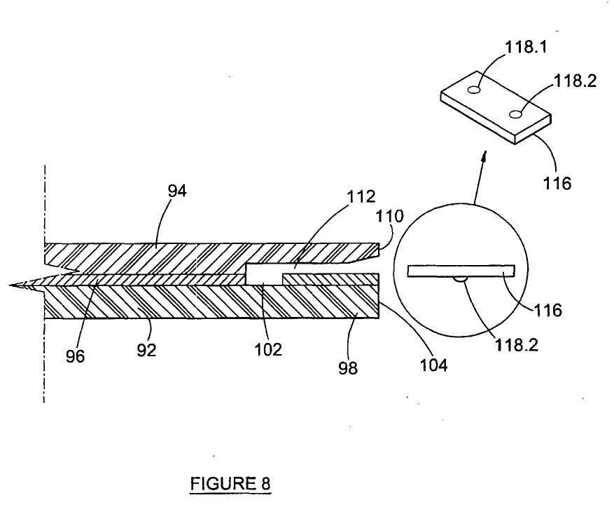

FIG. 8 is a radial section in a region of the transponder on the disc in FIG. 7;

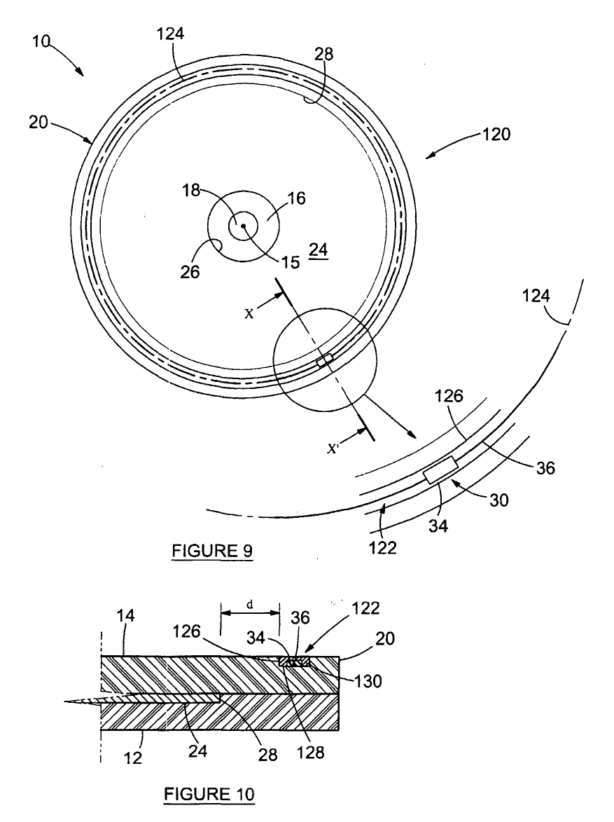

FIG. 9 is a plan view of a fifth embodiment of the disc according to the invention; and

FIG. 10 is a section on line X in FIG. 9.

### DESCRIPTION OF PREFERRED EMBODIMENTS OF THE INVENTION

An optical disc according to the invention is generally designated by the reference numeral 10 in FIG. 1 wherein it is shown in exploded form.

As in conventional optical discs, the disc 10 comprises a first generally flat and circular body part 12 and a generally flat and circular second body part 14. During manufacture the first and second body parts are superimposed on one another so that the resulting circular disc has a centre or main axis 15 and comprises a center region 16 defining a center hole 18 and a circular outer periphery 20. The body parts are made from a suitable dielectric material, such as a resinous or plastics material.

On an operative inside face 22 of the first body part there is provided in known manner a metal layer 24 comprising a circular inner boundary 26 adjacent the center region 16 and a coaxial circular outer boundary 28. Data to be stored on the disc 10 is written in known manner onto the disc by external writing means (not shown) locally manipulating the reflectivity of the layer 24 in accordance with the data. The second body part 14 is transparent.

The disc 10 according to the invention comprises at least a first tag 70 (shown in FIG. 5) comprising a radio frequency transponder 30. The tag or transponder is mounted on the inside face 22 of the first body part in an annular band 32 between the outer boundary 28 and the outer periphery 20 of the disc. The transponder 30 comprises an integrated circuit chip 34 and an antenna 36 configured in the form of a circle segment and which is bonded in known manner to the chip.

A second similar tag or transponder 38 is provided in a diametrically opposite region of the disc 10, to maintain the balance and/or stability of the disc while rotating in use.

In FIG. 2 there is shown the inside face of the first body part 42 of a second embodiment of the disc 40 according to the invention. The first body part 42 is similar to the first body part 12 shown in FIG. 1, except that the second tag is replaced by any suitable counter mass 44 other than a transponder, to main the balance and stability of the disc 40 in use. Although FIG. 2 illustrates the counter mass 44 in the annular band 32, the counter mass need not necessarily be located in the aforementioned annular band 32 and may be provided in any suitable place on the disc. In some embodiments it may not be necessary to provide or have a second tag, transponder or other counter mass.

Referring to FIG. 3, in a third embodiment of the disc 50, the first transponder 30 and the second transponder 38, alternatively the counter mass 44 are provided in a radially outer region on an inside face 52 of the second body part 14. At least the first transponder 30 is located in an annular band 54 coinciding with the band 32 and between outer boundary 28 and the outer periphery 20.

In FIGS. 4(a) and 4(b) there are shown sections on lines IV′ and IV″ respectively in FIG. 1. Hence, in FIG. 4(a) there is shown a section through second body part 14 and in FIG. 4(b) there is shown a section through first body part 12. In FIG. 4(b) there are shown chip 34 and antenna 36 of the first transponder 30. The metal plated metal layer 24 and antenna 36 may be deposited in the same metal plating or etching process to the same thickness. The second body part 14 defines sockets 60 for receiving protruding chip 34. In an embodiment such as the aforementioned third embodiment wherein the chip is provided on the second body part 14, the socket 60 is defined in the first body part 12. In other embodiments (not shown) the chip may be mounted in a socket or recess defined in the body part on which the chip is mounted.

In FIG. 5 there is shown a tag 70 for use on a disc according to the invention. The tag 70 comprises a dielectric flexible substrate 72 and a transponder 30 as hereinbefore described. The substrate 72 comprises lines 74 of weakness or perforations extending transversely to a longitudinal axis 73 of the substrate. The tag 70 may be adhered to an internal or external surface of the disc in the band 32. Should the tag be mounted on an external surface of the disc and should it be attempted to remove the tag, the tag would be severed along at least one of the lines 74 of perforations. As is clear in the figures, the antenna has a shape in the form of a circle segment. Such a shape would enable the tag to be read or interrogated from more directions than would be the case with a known linear antenna.

In FIG. 6 there is shown a stack 80 of superimposed discs 80.1 to 80.n. Each disc comprises a transponder 30.1 to 30.n located in an annular peripheral band 32.1 to 32.n, between a respective outer boundary 28 of a metal layer of the disc and an outer periphery of the disc 20. As is clear from FIG. 6, external readers 84.1 and 84.2 of an RFID system are sufficiently exposed to the transponders and the antennae to be able to read data stored in memory arrangements on the transponders, even while the discs are positioned in the stack 80.

In one preferred embodiment of the disc, the chip 34 is embedded in one of the two plastic body parts, before the two parts are bonded together. For this purpose a recess is formed in the surface of the relevant plastic body part during the moulding process, so that it will receive the chip. The metal antenna 36 is deposited onto this plastic body part, before the halves are bonded together. The chip 34 is fitted into the recess in the plastic body part using standard ‘flip-chip’ techniques, with the metal bonding pads of the chip in such a position that mechanical and electrical bonding with the metal antenna may be formed. The recess in the plastic body part is afterwards filled with a bonding glue. If the transponder 30 is formed on the inner surface of the plastic body part, the aforementioned procedure should ensure that the surface of the body part is sufficiently flat, so that the two parts may be bonded together. If the tag is formed on an external surface of any one of the plastic body parts, the aforementioned procedure should ensure that the chip is mechanically and electrically protected against shocks.

In FIGS. 7 and 8 there is shown a fourth embodiment of the disc according to the invention designated 90. The disc comprises body parts 92 and 94. The metal layer 96 and antenna parts 98 and 100 are plated on an inside face of the first part 92 in one plating or similar process. A gap or clear region 102 is provided between the antenna parts and the layer 96 and between the antenna parts themselves. The antenna parts are provided immediately adjacent the outer edge 104 of part 92. The body part 94 is transparent and defines in an operative inner surface 106 thereof a channel 108 extending from outer edge 110 thereof radially inwardly. As best shown in FIG. 8, when the first and second body parts are mounted or superimposed on one another, a funnel shaped socket 112 is defined in the outer peripheral region of the disc. The socket extends radially inwardly and bridges the region 114 between the two antenna parts.

The chip 116 is receivable in the socket 112, so that contacts 118.1 and 118.2 on the chips are brought into contact with pads 120.1 and 120.2 respectively on the antenna parts 98 and 100 respectively. The chip is urged into electrical contact with the pads by the body parts 92 and 94.

Instead of on the inside surface of body part 92, the antenna 98, 100 may in other embodiments be formed or provided on an axially and circumferentially extending surface provided by one or both of edges 104, 110 of the disc.

In FIGS. 9 and 10 there is shown a fifth embodiment of the optical disc according to the invention designated 120 and having a centre axis 15. This disc comprises an axially extending groove 122 provided on a circle 124 coaxial with the axis 15 and in a top or external surface of body part 14 towards the periphery 20. The groove may be in the form of a circle segment (not shown) or may be in the form of a full circle as shown. The tag 70 or transponder 30 comprising a chip 34 and an antenna 36 may be provided angularly anywhere in the groove with a top surface of the chip substantially flush with or recessed relative to a top surface of the body part 14. The metal layer 24 may extend past the groove substantially to the outer periphery 20 of the disk 120, or, the boundary 28 thereof may be radially spaced inwardly a distance d from an inside wall 126 of the groove 122 to reduce or minimize possible negative effects of the layer on the antenna circuitry.

The antenna may be printed on a floor 128 of the groove, alternatively the antenna may be provided as part of a tag as hereinbefore described or defined and the tag may be glued or otherwise applied in the groove. Once the transponder or tag has been applied or mounted, the tag or transponder may be covered with a resin 130 or other suitable material, in order to protect the transponder against mechanical wear and tear.

As stated hereinbefore the at least one transponder 30 is located in a region of the disc towards the outer periphery 20 of the disc. The transponder may be located in a region between 50% and 60% of the radius of the disc from the centre axis, alternatively between 60% and 70% of the radius, further alternatively between 70% and 80%, still alternatively between 80% and 100%, but most preferably between 90% and 100%.

1. An optical disc comprising a center and an outer periphery, a metal layer between the center and the outer periphery; and at least a first radio frequency transponder located in a region of the disc towards the outer periphery.

2. An optical disc as claimed in claim 1 wherein the at least first transponder is located between the metal layer and the outer periphery.

3. An optical disc as claimed in claim 2 wherein the disc is circular, wherein the metal layer has an inner circular boundary adjacent the center and an outer circular boundary adjacent the outer periphery of the disc, the at least first transponder being located in an annular band between the outer boundary and the outer periphery.

4. An optical disc as claimed in any one of claims 1 to 3 wherein the at least first transponder is mounted between first and second circular dielectric body parts of the disc superimposed on one another.

5. An optical disc as claimed in any one of claims 1 to 4 wherein the at least first transponder comprises a chip comprising electronic circuitry and an antenna configured in the form of a circle segment.

6. An optical disc as claimed in claim 5 wherein the first body part comprises the metal layer, the antenna being formed on an inside face of the first body part and the chip being located in a socket defined in one of the first body part and the second body part.

7. An optical disc as claimed in claim 6 wherein a second similar transponder is provided on one of the first and the second body parts in a region diametrically opposed to the at least first transponder.

8. An optical disc as claimed in claim 6 wherein a suitable counter mass for the at least first transponder is provided in any suitable place on the disc.

9. An optical disc as claimed in claim 4 wherein the at least first transponder is provided in a radially outer region of the second body part, so that when the first and second body parts are superimposed on one another, the at least first transponder is located in said annular band.

10. An optical disc as claimed in claim 9 wherein a second similar transponder is also provided on the second body part so that the second transponder is also located in said annular band.

11. An optical disc as claimed in claim 9 wherein a counter mass is provided for the at least first transponder in any suitable on of the disc.

12. An optical disc as claimed in claim 1 or claim 2 wherein the disc is circular having a centre axis and the transponder is mounted on an external surface in an axially extending groove defined on a circle coaxial with the centre axis.

13. A method of producing an optical disc, the method comprising the steps of providing a radio frequency transponder comprising a chip and antenna on the disc in a region thereof towards an outer periphery of the disc.

14. A method as claimed in claim 13 wherein the transponder is sandwiched between a first dielectric and circular body part of the disc and a second similar body part of the disc.

15. A method as claimed in claim 14 wherein the antenna is formed on an inside face of one of the first and second body parts of disc and wherein the chip is received in a radially inwardly extending peripheral socket in the disc.

16. A method as claimed in claim 13 wherein the transponder is provided on an external surface of the disc in an axially extending groove defined on a circle coaxial with a center of the disc.

17. A transponder comprising a chip comprising electronic circuitry and an antenna, the antenna being configured in the form of a circle segment and being connected to the chip.

18. A transponder as claimed in claim 17 mounted on a dielectric substrate configured in the shape of a circle segment.

19. A transponder as claimed in claim 18 wherein the substrate comprises lines of weakness extending transversely to a longitudinal axis of the substrate.
